(19) United States
(12) Patent Application Publication
(10) Pub. No.: US 2011/0162219 A1
(43) Pub. Date: Jul. 7, 2011

(54) HANDHELD ELECTRIC POWER TOOL

(75) Inventor: Katsumi OKOUCHI, Anjo-shi (JP)

(73) Assignee: MAKITA CORPORATION, ANJO-SHI (JP)

(21) Appl. No.: 12/976,082

(22) Filed: Dec. 22, 2010

(30) Foreign Application Priority Data
Jan. 4, 2010 (JP) 2010-000124

(51) Int. Cl. B27B 17/02; B25F 5/02

(52) U.S. Cl. 30/383; 173/217; 30/381

(57) ABSTRACT

A handheld electric power tool comprises a main body supporting a tool, a motor housed in the main body and configured to drive the tool, a battery interface disposed in a back portion of the main body and configured to detachably receive a battery pack, and a top grip disposed on a top portion of the main body. In a planar view of the main body, a center axis of the top grip extends in front and back direction and a center of gravity of the battery pack attached to the battery interface is located at one side of a straight line passing through the center axis of the top grip.

### CROSS-REFERENCE TO RELATED APPLICATION

This application claims priority to Japanese Patent Application No. 2010-000124 filed on Jan. 4, 2010, the contents of which are hereby incorporated by reference into the present application.

### TECHNICAL FIELD

The present application relates to handheld power tools that include, but are not limited to, electric chain saws, electric circular saws and electric blowers. Especially, the present application relates to a type of handheld power tools with a top grip or a top handle disposed on a top portion of its main body.

### RELATED ART

JP 2008-55711 A discloses an electric chain saw. The electric chain saw is a type of handheld electric power tools with a top grip. The electric chain saw comprises a saw chain and a main body having a guide bar for the saw chain. A motor is housed in the main body and configured to drive the saw chain. A battery interface configured to detachably receive a battery pack is disposed in a back portion of the main body. The top grip is provided on a top portion of the main body.

### SUMMARY

In the aforementioned power tool with the top grip, weight distribution with respect to the top grip is important. If a center of gravity of the power tool is horizontally offset with respect to a center axis of the top grip, the electric power tool will lean when a user holds the power tool at the top grip. Such imbalance causes inconvenience to the user.

Accordingly, it is an object of the present teachings to provide a technique for improving the weight distribution with respect to the top grip or the top handle.

Generally, a battery pack for an electric power tool is large and heavy. Therefore, the conventional power tool is designed such that, in a planar view of the main body, the center of gravity of the battery pack is located on a straight line passing through the center axis of the top grip. With this design, the heavy battery pack is prevented from influencing the weight distribution of the power tool with respect to the top grip.

On the contrary, the present teachings proposes a new design in which the battery pack is arranged to be horizontally displaced with respect to the center axis of the top grip. With this design, the weight distribution of the power tool may be drastically improved by using the heavy weight of the battery pack such that the center of gravity of the power tool is located on the straight line passing through the center axis of the top grip.

In one aspect of the present teachings, a handheld power tool may comprise a main body supporting a tool. A motor may be housed in the main body and configured to drive the tool. A battery interface may be disposed on a rear portion of the main body and configured to detachably receive a battery pack. A top grip may be provided on a top portion of the main body. In a planar view of the power tool, the top grip may extend along a front-to-rear direction of the main body and the center of gravity of the battery pack attached to the battery interface may be located at one side of a straight line passing through the center axis of the top grip.

### BRIEF DESCRIPTION OF DRAWINGS

FIG. 1 shows a side view of a chain saw of an embodiment.

FIG. 2 shows a planar view of the chain saw

FIG. 3 shows a side view of the chain saw with an adapter attached in replacement of the battery pack.

FIG. 4 shows the chain saw held at a top grip with the battery pack attached to the battery interface.

FIG. 5 shows the chain saw held at the top grip with the adapter attached to the battery interface.

FIG. 6 shows a hanging ring housed within a storage space of the main body.

FIG. 7 shows the hanging ring being out of the storage space of the main body.

FIGS. 8A, 8B, 8C and 8D show a schematic planer view of the chain saw, respectively wherein FIG. 8A corresponds to FIG. 2 and FIGS. 8B to 8D show alternative possibilities of attaching a battery pack to a battery interface of the chain saw.

### DETAILED DESCRIPTION

In one embodiment of a handheld electric power tool of the present teachings, a motor may be disposed at one side of a straight line passing through a center axis of a top grip in a planar view. In this case, a battery pack may be preferably disposed at an opposite side of the motor with respect to the straight line passing through the center axis of the top grip. That is, in the planar view of the power tool, a center of gravity of the battery pack and a center of gravity of the motor may be preferably located at the opposite side of each other with respect to the straight line passing through the center axis of the top grip. In this design, a relatively heavy weight of the motor may at least partly be cancelled with the weight of the battery pack.

In one embodiment of the present teachings, the power tool may comprise an oil tank housed in the main body. In this case, a center of gravity of the oil tank may preferably be located at the opposite side of the center of gravity of the motor with respect to the straight line passing through the center axis of the top grip in the planar view of the power tool. In this design, the relatively heavy weight of the motor may at least partly be cancelled with the weight of the oil tank, which may improve the weight distribution of the power tool with respect to the top grip.

In one embodiment of the invention, the battery interface may be configured to receive an adapter for connecting the power tool to an AC power source in replacement of the battery pack. In this case, note that the weight distribution of the power tool may relatively change in the front-to-rear direction between a state where the battery pack, being relatively heavy, is attached and a state where the adapter, being relatively light, is attached. Accordingly, if the weight distribution of the power tool is optimized with the battery pack attached, the center of gravity of the power tool will lean frontward when the adapter is attached in replacement of the battery pack. Likewise, if the weight distribution of the power tool is optimized with the adapter attached, the center of gravity of the power tool will lean rearward when the battery pack is attached in replacement of the adapter.

Accordingly, in the embodiment of the present teachings, the power tool is preferably designed such that the main body leans rearward when the main body is held at the top grip with the battery pack attached to the battery interface and the main body leans frontward when the main body is held at the top grip with the adapter attached to the battery interface.

In this configuration, the power tool is intentionally allowed to lean to a certain degree in each state of the battery pack or the adapter attached, which may prevent the power tool from leaning beyond to an permitted degree in each condition of the battery pack or the adapter attached.

In the above configuration, the center of gravity of the motor may preferably be located rearward with respect to a position where a middle finger is arranged when the user grasps the top grip. With this configuration, it may be easy to embody the weight distribution mentioned above without rearrangement of other components.

The aforementioned designs and configurations may preferably apply to the chain saw that comprises a saw chain and a main body having a guide bar for the chain saw, however, are not limited to such an application.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved electric power tools, as well as methods for using and manufacturing the same.

Moreover, combinations of features and steps disclosed in the following detail description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EMBODIMENT

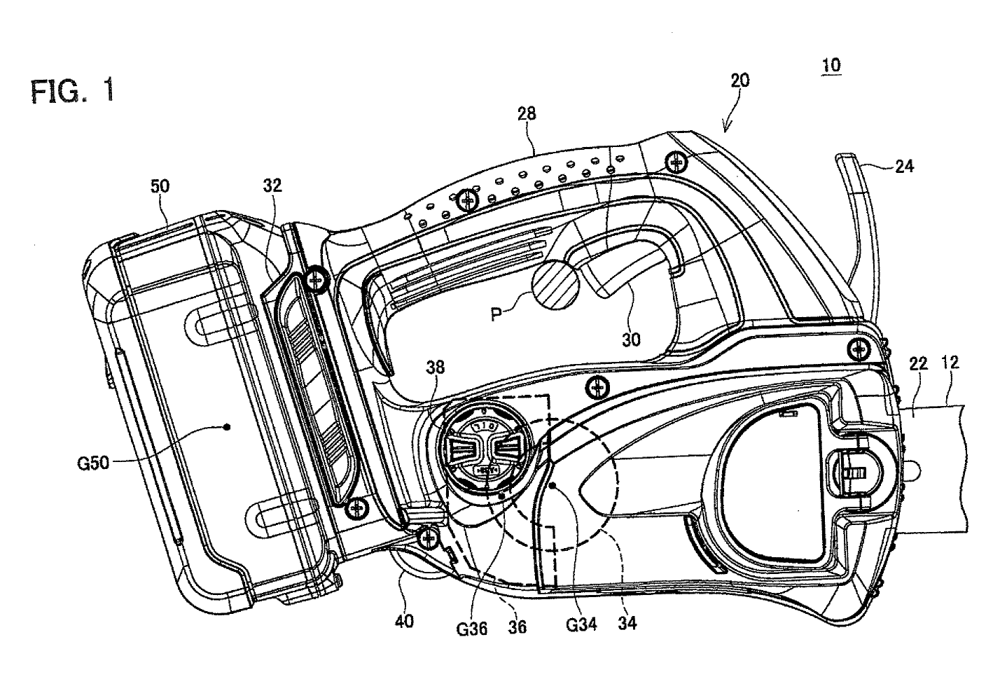

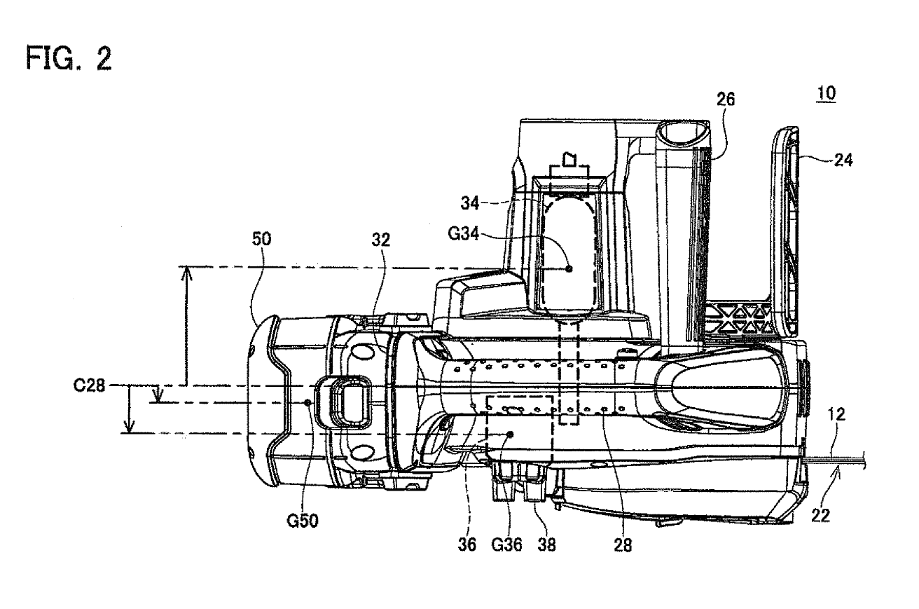

Referring the drawings, a chain saw 10 of a specific embodiment will be described below. The chain saw 10 of the present embodiment is a type of handheld electric power tool for cutting a timber. As shown in FIGS. 1 and 2, the chain saw 10 is provided with a saw chain 12 and a main body 20 for driving the saw chain 12 to turn. The saw chain 12 has a plurality of small blade edges (not shown), and cuts a timber by contacting while turning.

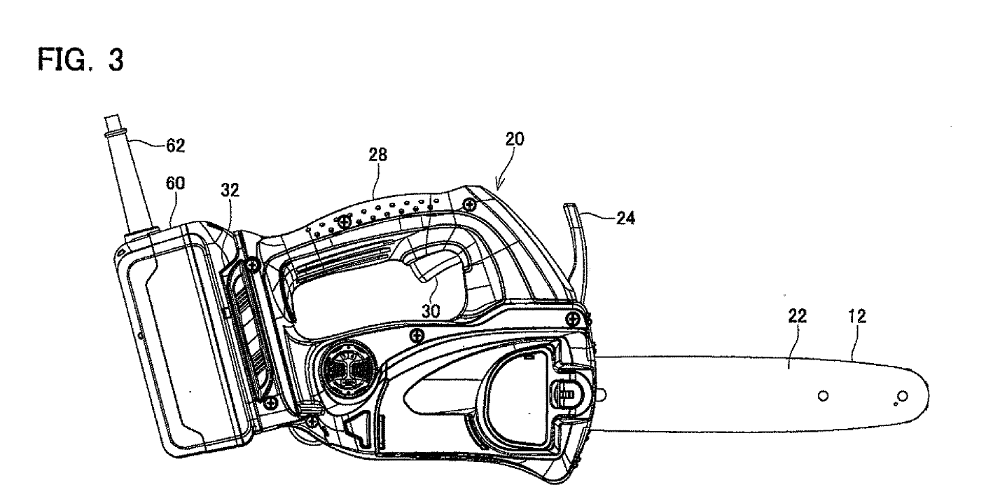

The main body 20 is provided with a guide bar 22. The guide bar 22 extends frontward (rightward in FIGS. 1 and 2) from the main body 20. The saw chain 12 is arranged around the guide bar 22 and the guide bar 22 supports the saw chain 12 in a manner of allowing the saw chain to turn. The saw chain 12 is arranged around not only the guide bar 22 but also a sprocket (not shown) housed in the main body 20. Such configuration is the same as conventional chain saws and the chain saw 10 of the present embodiment is not limited to a specific configuration in this respect. Although FIGS. 1 and 2 show only a part of the saw chain 12 and the guide bar 22, the saw chain 12 and the guide bar 22 are entirely shown in FIG. 3.

A motor 34 is housed in the main body 20. The motor 34 is connected to the aforementioned sprocket and drives the saw chain 12 around the guide bar 22 by rotating the sprocket. As shown in FIG. 2, the motor 34 is arranged so as to protrude from one side of the main body 20 and a rotary shaft of the motor 34 extends substantially perpendicular to the front-to-rear direction (which is right-to-left direction in FIGS. 1 and 2) of the main body 20. A dot G34 shown in FIGS. 1 and 2 indicates a center of gravity of the motor 34. Hereinafter the center G34 of gravity of the motor 34 is simply called as the motor's gravity center G34.

The main body 20 is provided with a battery interface 32. The battery interface 32 is configured to removably receive the battery pack 50. The battery interface 32 is arranged at a rear portion of the main body 20 (left portion in FIGS. 1 and 2). The battery pack 50 houses a plurality of rechargeable battery cells and is configured to be repeatedly recharged. A dot G50 shown in FIGS. 1 and 2 indicates a center of gravity of the battery pack 50. Hereinafter the center of gravity G50 of the battery pack 50 is simply called as the battery's gravity center G50. Although it is just an example, the battery pack 50 of the present embodiment comprises ten battery cells connected in series and has a nominal voltage of 36 volt. In greater detail, the battery pack 50 comprises twenty battery cells in total and ten pairs of parallel-connected battery cells are connected in series.

The main body 20 is provided with a top grip 28 and a front grip 26. The top grip 28 and the front grip 26 are configured to be grasped by a user. As shown in FIG. 2, in a planar view of the main body 20, the top grip 28 extends along the front-to-rear direction of the main body 20. A straight line C28 shown in FIG. 2 is a straight line passing through the center axis of the top grip 28. Hereinafter the straight line C28 passing through the center axis of the top grip 28 is simply called as the grip's centerline. A hand guard 24 that is connected to an emergency braking mechanism is provided in front of the front grip 26. Usually, the user holds the chain saw 10 with his/her right hand grasping the top grip 28 and his/her left hand grasping the front grip 26.

The top grip is provided with a trigger 30 that is operated by the user to activate and deactivate the motor 34. The trigger 30 normally is operated with an index finger of the right hand grasping the top grip 28. In this case, a middle finger of the right hand is located at a position P shown in FIG. 1. As well as other kinds of handheld power tools with a top grip, the weight of the chain saw 10 is mainly supported by the middle finger of the right hand grasping the top grip 28. Accordingly, in this field of handheld power tools with the top grip, it is general that the weight distribution in the front-to-rear direction is judged with reference to the point P shown in FIG. 1 (e.g. EU directive). Also in the present embodiment, as will be described in detail in the latter part, the weight distribution in the front-to-rear direction is also judged with reference to the point P. Hereinafter the point P where the middle finger is located is simply called as the balance judgment point.

The main body 20 further includes an oil tank 36. The oil tank 36 is configured to store lubricant oil and supply the stored lubricant oil to the sprocket and saw chain 12. The oil tank 36 is provided with an oil cap 38. The oil cap 38 is configured to be removed when the user feeds the oil tank 36 with the lubricant oil. A dot G36 shown in FIGS. 1 and 2 indicates a center of gravity of the oil tank 36 filled with the lubricant oil. Hereinafter the center of gravity G36 of the oil tank 36 is simply called as the tank's gravity center.

Furthermore, a hanging ring 40 is provided to the main body 20. The hanging ring 40 is attached to a bottom portion of the main body 20. The hanging ring 40 is configured capable of shifting between an outer position where the hanging ring 40 is put out from the main body 20 and an inner position where the hanging ring 40 is substantially housed within the main body 20. Note that FIG. 1 shows the hanging ring 40 located in the inner position. The hanging ring 40 is used to raise the chain saw 10 up to a high place with a rope when the user uses the chain saw 10 in the high place. For example, when the user uses the chain saw 10 on a tree, the user ties the rope to the hanging ring 40 and climbs the tree while holding the rope. Then, the user raises the chain saw 10 up to the tree by pulling the rope. In this case, the user does not need to climb the tree while holding the chain saw 10. Note that some country and region obligates to provide the hanging ring 40 or a similar type of hanging member to the chain saw 10 (e.g. the EU directive). A detailed configuration of the hanging member 40 will be described in the latter part.

Hereinbefore the overall structure of the chain saw 10 has been described. Hereinafter specific features of the chain saw 10 will be described. As shown in FIG. 2, the battery's gravity center G50 is offset at one side of the grip's centerline C28 in the planar view of the main body 20. Specifically, the battery's gravity center G50 is located at the opposite side of the motor's gravity center G34 with respect to the grip's centerline C28. With this design, the weight of the motor 34 can be cancelled with the weight of the battery pack, which may cause a good weight distribution. Note that the conventional products are designed such that the battery's gravity center G50 is located on the grip's centerline C28 to prevent the weight of the battery pack 50 from influencing the weight distribution with respect to the top grip 28. On the contrary, the present embodiment is intentionally designed such that the battery's gravity center G 50 is located at one side of the grip's centerline C28. With this design, unbalanced weight distribution mainly caused by the weight of the motor 34 is reduced by using the weight of the battery pack 50.

In addition, as shown in FIG. 2, the tank's gravity center G36 is located at the opposite side of the motor's gravity center G34 with respect to the grip's centerline C28. Accordingly, the relatively heavy weight of the motor 34 may be cancelled with the weight of both the battery pack 50 and the oil tank 36, which may further improve the weight balance of the chain saw 10.

The above-mentioned features relate to weight distribution of the chain saw 10 in the right-to-left direction. Next, weight distribution of the chain saw 10 in the front-to-rear direction will be described. As shown in FIG. 3, the battery interface 32 of the chain saw 10 is configured capable of receiving an adapter 60 in replacement of the battery pack 50. The adapter 60 is provided with an electric cord 62 (partly not shown) configured to be connected to an external AC power supply (i.e. a power outlet). The adapter 60 is configured to convert AC power from the AC power supply to DC power and supply the DC power to the chain saw 10. Accordingly, the user may use the chain saw 10 with the adapter 60 in a situation where the AC power supply is available (e.g. indoors), and use the chain saw 10 with the battery pack 50 in a situation where the AC power supply is not available (e.g. outdoors).

Comparing the battery pack 50 and the adapter 60, the battery pack 50 is larger and heavier than the adapter 60 and a difference of weight between them is relatively large. Accordingly, the weight distribution of the chain saw in the front-to-rear direction may significantly change between a case where the battery pack 50 is attached to the main body 20 and a case where the adapter 60 is attached to the main body 20. If the weight distribution of the chain saw 10 is optimized with the battery pack 50 attached, the chain saw 10 leans frontward when the adapter 60 is attached in replacement of the battery pack 50. Similarly, if the weight distribution is optimized with the adapter 60 attached, the chain saw 10 leans backward when the battery pack 50 is attached in replacement of the adapter 60.

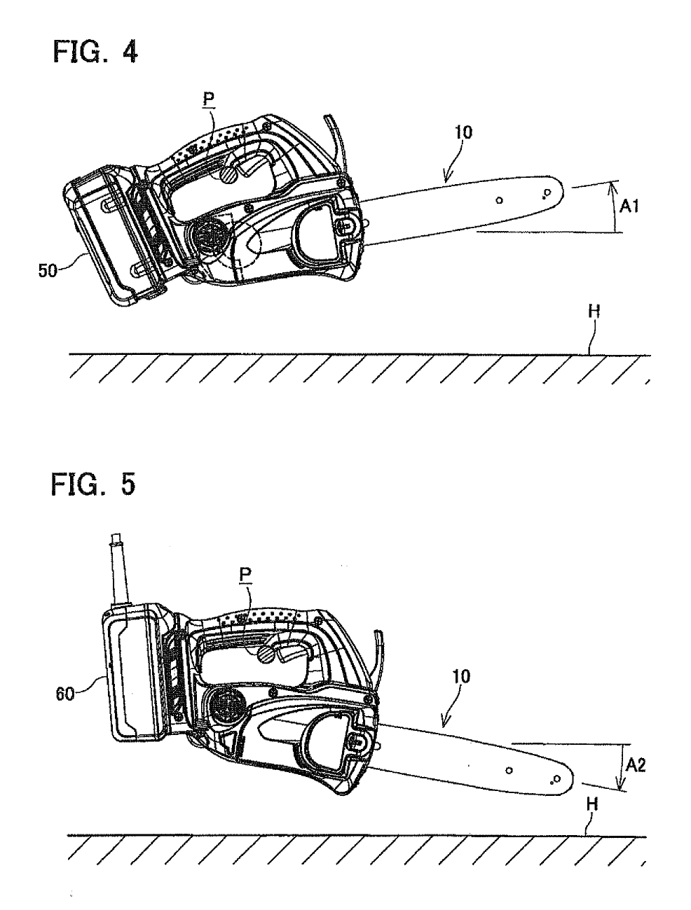

Therefore, the chain saw 10 of the present embodiment is designed so as to lean backward when the chain saw 10 is held at the top grip 28 with the battery pack 50 attached to the battery interface 32 and to lean frontward when the chain saw 10 is held at the top grip 28 with the adapter 60 attached to the battery interface 32. In detail, as shown in FIG. 4, the chain saw 10 of the present embodiment with the battery pack 50 attached leans backward by an angle A1 with respect to a horizon H when being held at the balance reference point P. And, as shown in FIG. 5, the chain saw 10 of the present embodiment with the adapter 60 attached leans frontward by an angle A2 with respect to the horizon H when being supported at the balance reference point P.

As described above, the chain saw 10 is designed to lean backward when the relatively heavy battery pack 50 is attached, which prevent the chain saw 10 from largely leaning to the front side when the relatively light adapter 60 is attached. In other words, the chain saw 10 is designed to lean frontward when the relatively light adapter 60 is attached, which prevents the chain saw 10 from greatly leaning to the back side when the relatively heavy battery pack 50 is attached. Thus, the chain saw 10 is designed to lean frontward and backward with a certain degree when the battery pack 50 and the adapter 60 is attached respectively. As a result, the chain saw 10 is prevented from leaning to the front and back side beyond a permissive degree. Here, the chain saw 10 of the present embodiment is designed such that the aforementioned angles A1 and A2 do not exceed 15 degrees respectively.

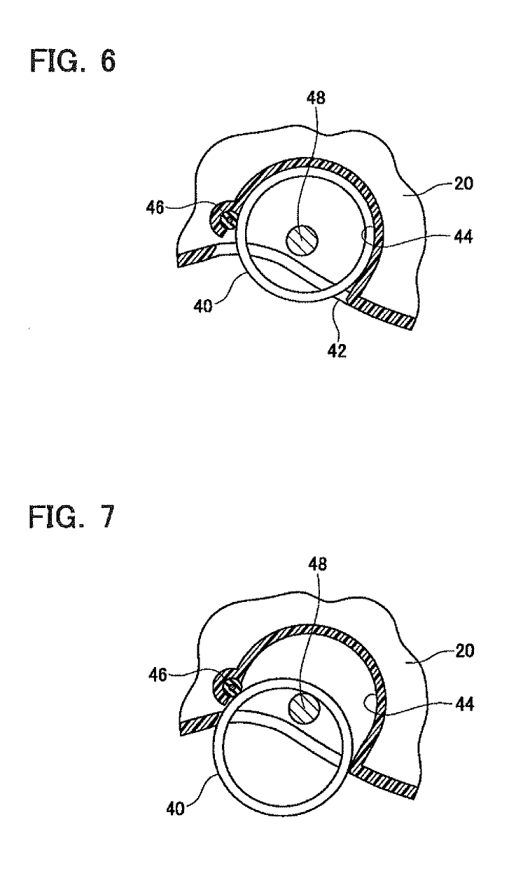

Hereinafter another feature of the chain saw 10 of the present embodiment will be described. As previously described, the main body 20 is provided with the hanging ring 40. FIGS. 6 and 7 show a structure of holding the hanging ring 40 of the main body 20. Note that the hanging ring 40 is located in the inner position in FIG. 6 and the hanging ring 40 is located in the outer position in FIG. 7. As shown in FIGS. 6 and 7, the main body 20 is provided with a storage space 44 in which the hanging ring 40 is disposed. The storage space 44 is a kind of depression and capable of partly storing the hanging ring 40. The hanging ring 44 is supported by the storage space 44 in a manner that allows its moving in and out therefrom. A stopper pin 48 and a positioning pin 46 are disposed within the storage space 44. The stopper pin 48 and the positioning pin 46 are fixed to the main body 20 respectively.

The stopper pin 48 is arranged inside of the hanging ring 40 and prevents the hanging ring 40 from coming off from the storage space 44. That is, the hanging ring 40 can move out from the main body 20 to the outer position where the stopper pin 48 contacts with the hanging ring 40. When the hanging ring 40 moves the outer position, the hanging ring 40 is supported by the stopper pin 48, an opening 42 of the storage space and the positioning pin 46.

The positioning pin 46 is configured to contact with the hanging ring 40 from the outside. The positioning pin 46 has a surface which is made of rubber and elastically deformed in contact with the hanging ring 40. When the hanging ring 40 moves to the outer position, the positioning pin 46 keeps the hanging ring 40 in the outer position with the elastic force. In addition, when the hanging ring 40 moves to the inner position, the elastic force of the positioning pin 46 turns over and works to keep the hanging ring 40 in the inner position.

As described above, the hanging ring 40 is disposed within the storage space 44 and is supported by the stopper pin 48 from the inside. According to this configuration, when the hanging ring 40 is struck against a floor or wall, the hanging ring 40 can be retracted in various directions according to a direction of the striking. Thus, the hanging ring 40 and the holding structure for the hanging ring 40 of the main body 20 are effectively prevented from breaking and being damaged.

Additionally, in the present embodiment, when the hanging ring 40 is stored in the storage space 44, the hanging ring 40 is not entirely housed within the storage space 44 but a part of the hanging ring 40 is out of the storage space 44. According to this configuration, the user directly puts his/her fingers on the hanging ring 40 housed within the storage space 44 and easily moves it to the outer position.

Furthermore, in the present embodiment, when the hanging ring 40 moves to the outer position, the hanging ring 40 is kept in the outer position by the elastic force of the positioning pin 46. By keeping the hanging ring 40 in the outer position, the user can easily tie a rope or belt to the hanging ring 40. The positioning pin 46 is also configured to keep the hanging ring 40 in the inner position by the elastic force when the hanging ring 40 moves to the inner position. By keeping the hanging ring 40 in the inner position, the hanging ring 40 is prevented from striking a floor or wall in advance.

Specific embodiment of the present teachings is described above, but this merely illustrates some representative possibilities for utilizing the teachings and does not restrict the claims thereof. The subject matter set forth in the claims includes variations and modifications of the specific examples set forth above. For example, the technique of the present embodiment regarding weight distribution can be applied to various types of handheld electric power tools including, but not limited to, an electric circular saw and an electric blower.

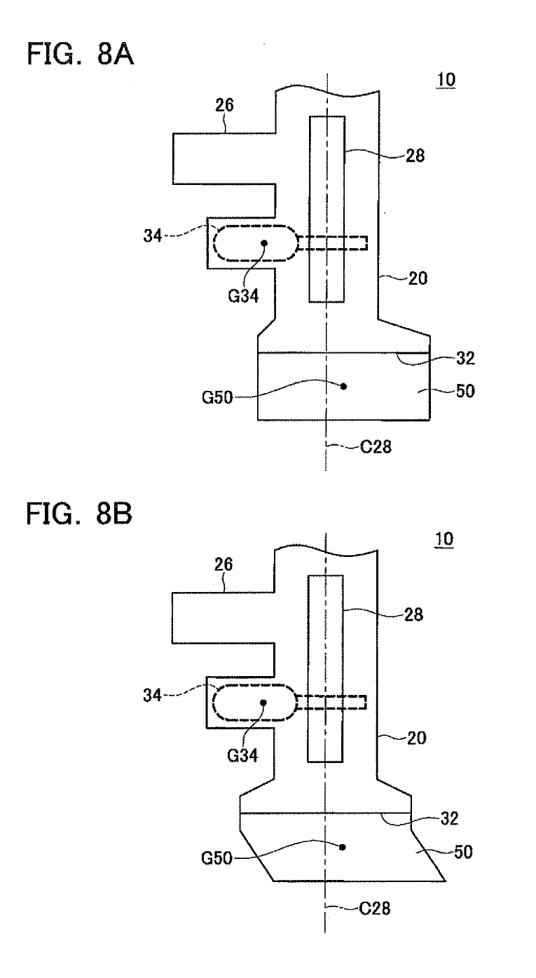

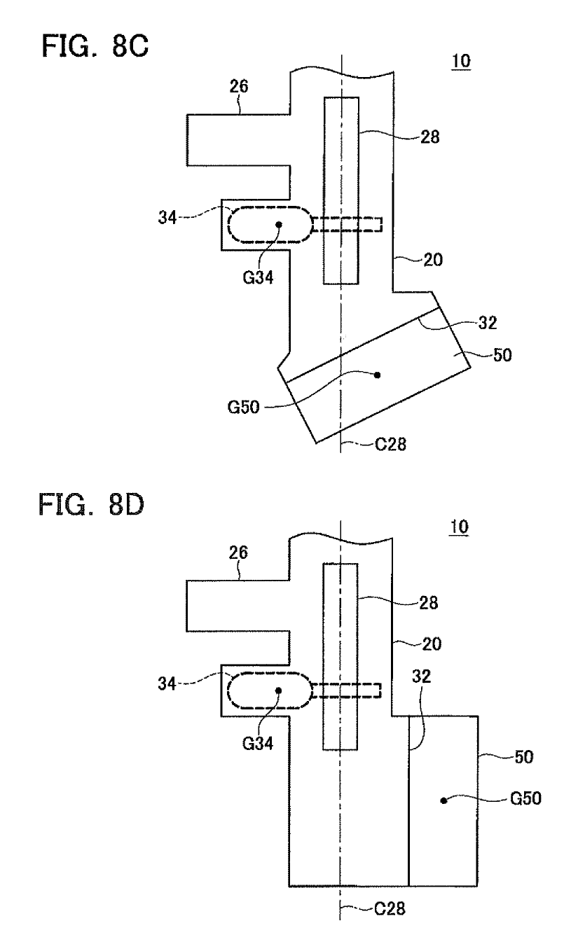

In the embodiment described above, the center line of the battery interface 32 arranged at a rear portion of the main body 20 is located, in the planer view of the main body 20, on the opposite side of the grip's centerline C28 in relation to the center of gravity G34 of the motor 34 (see FIG. 8A). That means, in particular, in case of a sliding attachment of the battery pack 50 and the use of a battery pack with a symmetrical weight distribution, the center of gravity G50 of the battery pack 50 is correspondingly offset in relation to the grip's centerline C28.

In another embodiment as shown in FIG. 8B, the battery pack 50 is formed such that the center of gravity G50 of the battery pack 50 is offset with respect to the center line of the battery pack 50 for sliding attachment to the main body 20 of the power tool 10. Accordingly, by using such an asymmetric battery pack 50, the center of gravity G50 can be located on one side of the grip's centerline C28. Another possibility (see FIG. 8C) is to arrange the battery interface 32 adapted for sliding attachment of the battery pack 50, in a planer view of the main body 20 from the top, inclined with respect to the grip's centerline C28. A further possibility (see FIG. 8D) is to arrange the battery interface 32, in a planar view of the main body 20 from the top, completely on one side of the straight line C28, for example on the lateral side of the main body 20 opposite to the lateral side of where the motor 34 is arranged.

Accordingly, there are plural and different designs resulting the center of gravity of the battery pack is arranged offset with respect to the straight line C28 in a planer view of the main body 20 from the top, in particular on the side opposite to the center of gravity G34 of the motor in relation to the grips' centerline C28. The same applies with respect to the attachment of the adapter 60 described with respect to FIG. 3.

Furthermore, it is preferred to have a distance d≧5 mm of the center of gravity G50 or the center line of the battery interface, respectively, in a planer view of the main body from the top with respect to the straight line C28. Not withstanding the minimum distance, it is preferred to have a distance d in the range of 8 to 20 mm.

What is claimed is:

1. A handheld electric power tool comprising:
a main body supporting a tool;
a motor housed in the main body and configured to drive the tool;
a battery interface disposed in a rear portion of the main body and configured to detachably receive a battery pack; and
a top grip disposed on a top portion of the main body, wherein, in a planar view of the main body, the top grip extends along a front-to-rear direction and a center of gravity of the battery pack attached to the battery interface is located at one side of a straight line passing through a center axis of the top grip.

2. A handheld power tool as in claim 1, wherein, in the planar view of the main body, the center of gravity of the battery pack is located in an opposite side of a center of gravity of the motor with respect to the straight line passing through the center axis of the top grip.

3. A handheld power tool as in claim 1, further comprising an oil tank disposed in the main body, wherein, in the planar view of the main body, a center of gravity of the oil tank is located in an opposite side of the center of gravity of the motor with respect to the straight line passing through the center axis of the top grip.

4. A handheld power tool as in claim 1, wherein
the battery interface is configured to detachably receive an adapter to be connected to an AC power supply in replacement of the battery pack,
the main body leans rearward when the main body is held at the top grip with the battery pack attached to the battery interface, and
the main body leans frontward when the main body is held at the top grip with the adapter attached to the battery interface.

5. A handheld power tool as in claim 4, wherein a center of gravity of the motor is located rearward with respect to a position of a middle finger of a hand grasping the top grip.

6. A handheld power tool as in claim 1, wherein the handheld power tool is a chain saw having a saw chain as the tool.

7. A handheld power tool as in claim 6, further comprising a guide bar extending frontward from the main body and supporting the saw chain.
